(19) United States
(12) Patent Application Publication
(10) Pub. No.: US 2008/0043994 A1
(43) Pub. Date: Feb. 21, 2008

(54) TELEPHONE HAVING PUBLIC-ADDRESS SYSTEM

(75) Inventors: Xiao-Zhu Chen, Shenzhen (CN); Zhen-Xing Ye, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,803

(22) Filed: Sep. 28, 2006

(30) Foreign Application Priority Data
Aug. 4, 2006 (CN) 200610061975.0

(51) Int. Cl. H04M 9/00

(52) U.S. Cl. 379/388.01

(57) ABSTRACT

A telephone having a PA system includes a telephone set, a handset, a conversion module, and an external loudspeaker. The telephone set is electrically connected to the handset via the conversion module. The external loudspeaker is electrically coupled to the conversion module.

### 1. FIELD OF THE INVENTION

The present invention relates to telephones, and more particularly to a telephone having a public-address (PA) system.

### 2. DESCRIPTION OF RELATED ART

With rapid development of communication technologies, teleconferences have become a preferred method for long distance business communications.

Typically, teleconferences are at the mercy of small internal microphones and loudspeakers of the telephone which fail to provide quality sound reproduction. Typically, in a teleconference, all the participants at one end of a phone conference share just one telephone and have to pass it back forth to keep the telephone with it's built in microphone close to a current speaker, which is unwieldy and time consuming.

What is desired, therefore, is a telephone having an external PA system for amplifying voices thereof.

### SUMMARY OF THE INVENTION

In one preferred embodiment, a telephone having a PA system includes a telephone set, a handset, a conversion module, and an external loudspeaker. The telephone set is electrically connected to the handset via the conversion module. The external loudspeaker is electrically coupled to the conversion module.

Other advantages and novel features will become more apparent from the following detailed description of preferred embodiments when taken in conjunction with the accompanying drawings, in which:

### BRIEF DESCRIPTION OF THE DRAWINGS

FIG. 1 is an isometric, schematic view of a telephone having a PA system in accordance with a preferred embodiment of the present invention;

FIG. 2 is a block diagram of FIG. 1; and

FIG. 3 is a circuit diagram of FIG. 1.

### DETAILED DESCRIPTION OF THE INVENTION

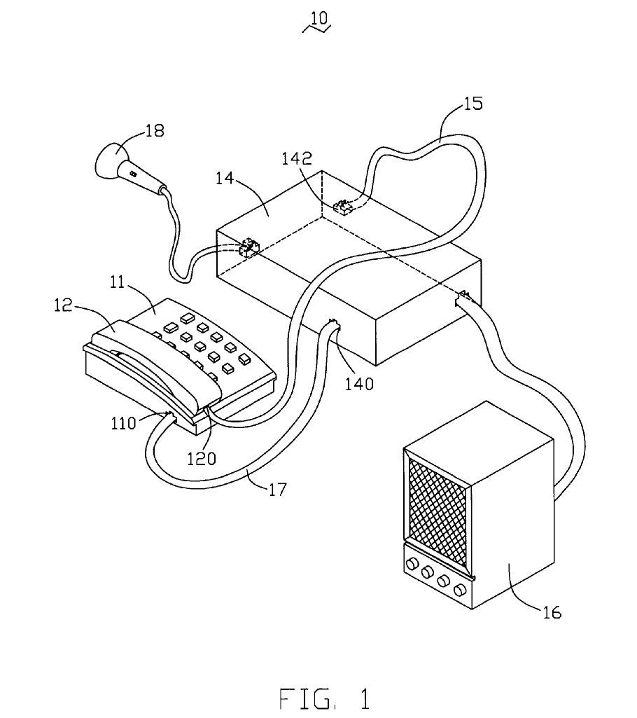

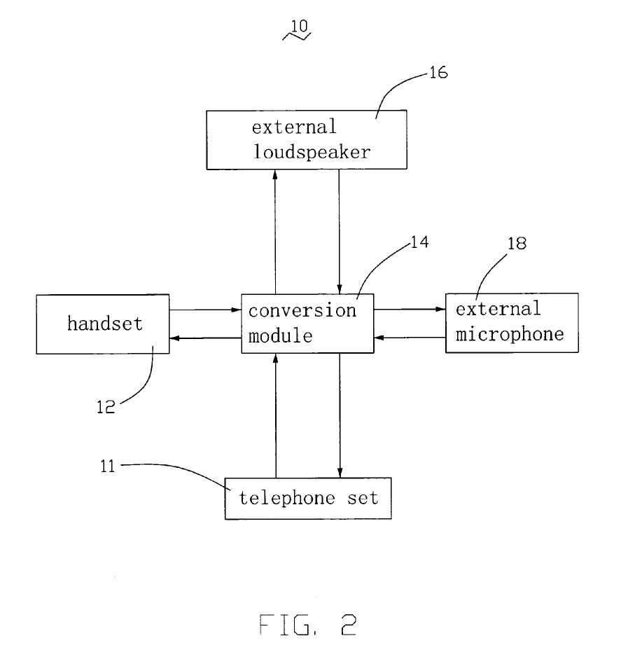

Referring to FIGS. 1 and 2, a telephone 10 having a PA system in accordance with a preferred embodiment of the present invention includes a telephone set 11, a handset 12, a conversion module 14, an external loudspeaker 16, and an external microphone 18. The handset 12 is removably attached to the telephone set 11 and electrically connected to the telephone set 11 via the conversion module 14. Both the external loudspeaker 16 and the external microphone 18 are located outside of the handset 12 and electrically coupled to the conversion module 14.

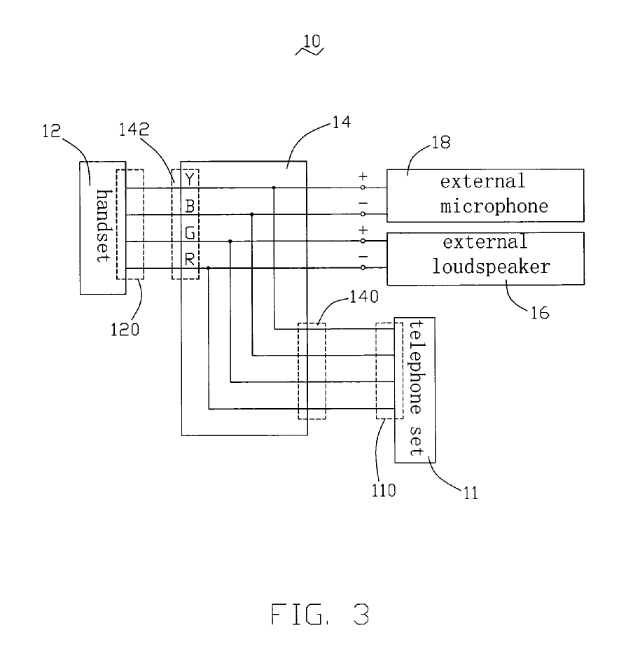

Referring also to FIG. 3, the telephone set 11, and the handset 12 may be parts of a conventional telephone on the market. One side of the telephone set 11 has a connecting interface 110, and an end of the handset 12 has a connecting interface 120. The connecting interfaces 110, 120 both have four terminals. The conversion module 14 includes a first interface 140, a second interface 142, and four signal lines Y, B, G, and R. The signal lines Y, B are used for inputting/outputting transmitting signals, and the signal lines G, R are used for inputting/outputting receiving signals. The connecting interface 110 of the telephone set 11 is electrically connected to the first interface 140 of the conversion module 14 via an electrical wire 17. The connecting interface 120 of the handset 12 is electrically coupled to the second interface 142 of the conversion module 14 via an electrical wire 15. A positive terminal (+) and a negative terminal (−) of the external loudspeaker 16 are electrically connected to the signal lines G, R of the conversion module 14 respectively. A positive terminal (+) and a negative terminal (−) of the external microphone 18 are electrically connected to the signal lines Y, B of the conversion module 14 respectively.

In a teleconference, the handset 12 of the telephone 10 is picked up from the telephone set 11 releasing a standard hook switch (not shown), then both the external loudspeaker 16 and the external microphone 18 are activated. The external loudspeaker 16 ready to amplifying received voice signals from the external microphone 18, which can be easily passed among users, is ready to pick-up sound. Note the handset 12 is operable as normal and may be used for private listening as needed and with the speaker 16 turned off.

The external loudspeaker 16 is better able to produce quality amplified voice signals according to the preferred embodiment of the present invention than conventional built-in loudspeakers of telephones. It is obvious that using the external microphone 18 is advantageous as it is simpler and easier to pass around among speakers than a conventional phone. Also, an external PA system includes the conversion module 14, the external loudspeaker 16, and the external microphone 18 is easy to be applied in any conversational phones.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

What is claimed is:

1. A telephone having a public-address system comprising:
a telephone set;
a handset connected to the telephone set;
a conversion module electrically connecting the telephone set to the handset; and
an external loudspeaker electrically coupled to the conversion module.

2. The telephone as claimed in claim 1, further comprising a movable external microphone electrically connected to the conversion module.

3. The telephone as claimed in claim 2, wherein one side of the telephone set, and an end of the handset each have a connecting interface; the conversion module comprises a first interface, a second interface, and a plurality of signal lines electrically connecting the first and second interfaces; the connecting interface of the telephone set is electrically connected to the first interface, the connecting interface of the handset is electrically coupled to the second interface; and corresponding signal lines of the conversion module are electrically connected to a positive terminal and a negative terminal of the external microphone respectively.

4. The telephone as claimed in claim 1, wherein one side of the telephone set, and an end of the handset each have a connecting interface; the conversion module comprises a first interface, and a second interface; the connecting interface of the telephone set is electrically connected to the first interface, the connecting interface of the handset is electrically coupled to the second interface.

5. The telephone as claimed in claim 4, wherein the conversion module further includes a plurality of signal lines electrically connecting the first and second interfaces; and corresponding signal lines of the conversion module are electrically connected to a positive terminal and a negative terminal of the external loudspeaker respectively.

6. A telephone having a public-address system comprising:
a telephone set;
a handset removably attached to the telephone set;
a conversion module electrically connecting the telephone set to the handset;
an external microphone located outside of the handset electrically coupling to the conversion module; and
an external loudspeaker located outside of the handset electrically coupled to the conversion module.
